(19) United States
(12) Patent Application Publication
(10) Pub. No.: US 2019/0160440 A1
(43) Pub. Date: May 30, 2019

(54) MULTI-STAGE AERATION GENERATOR AND METHOD OF SEWAGE TREATMENT

(71) Applicant: Cheeching YIP, Kuichong Subdistrict (CN)

(72) Inventor: Cheeching YIP, Kuichong Subdistrict (CN)

(21) Appl. No.: 16/309,425

(22) PCT Filed: Jun. 27, 2017
(86) PCT No.: PCT/CN2017/090166

§ 371 Date: Dec. 12, 2018

(30) Foreign Application Priority Data
Jun. 27, 2016 (CN) 201610499009.0

(51) Int. Cl. B01F 5/04; C02F 1/24; B01F 3/04; B01F 15/00

(52) U.S. Cl. CPC B01F 5/0413; C02F 1/24; B01F 3/04248; B01F 15/00162; C02F 2209/03; B01F 2003/04319; B01F 2003/04872; B01F 2005/0438; B01F 2005/0448; C02F 2201/002

(57) ABSTRACT

A multi-stage aeration generator, comprising a generator body (1). A pressure monitoring device (2) and a venturi nozzle (3) are installed on the generator body (1). The generator further comprises: a capillary tube (4) and a concentric tube (5). One end of the capillary (4) is connected to the venturi nozzle (3), and the other end thereof is connected to the concentric tube (5). Also disclosed is a wastewater treatment method using the multi-stage aeration generator.

### TECHNICAL FIELD

Present invention relates to the field of wastewater treatment, more particularly, relates to a multi-stage aeration generator and a method of wastewater treatment.

### BACKGROUND

Dissolved air flotation (DAF) has been broadly applied for wastewater treatment for more than a century. Dissolved air flotation process can produce fine bubbles. Hydrophobic particles leave liquid, wherein adsorbed bubbles are concentrated or waste is filtered, such as molecules, colloids or large particles. Wastes on surface of the bubbles are optionally absorbed, and separation efficiency mostly depends on quantity and volumes of bubbles, and the rest part depends on the difference between their surface activity. The obvious disadvantages of conventional wastewater treatment system are that, first, huge space is occupied by the apparatus, which greatly increases the production and operation cost; second, the apparatus lacks flexibility of production due to self-load parameters (air supply and pump speed) cannot be responded by output (bubble density and flow speed) immediately, it is thereby necessary to provide a multi-stage aeration generator to solve the aforementioned problems.

### SUMMARY

Present invention is aimed to overcome at least one disadvantage or shortage described in the prior art.

The primary purpose of present invention is provided a multi-stage aeration generator, and the corresponding technical solution is as follows:

a multi-stage aeration generator, comprises generator body, a pressure monitoring device installed thereon and a venturi nozzle, and further comprises a capillary tube and a concentric tube, wherein one end of the capillary tube is connected to the venturi nozzle, and the other end is connected to the concentric tube. Present invention has novel design, and a combination of the venturi nozzle and the concentric tube, can provide very fine foam continuously and stably, at the same time it can change output immediately in response to changes of operating parameters input; the multi-stage aeration generator is used to adjust and control air feeding and pump speed to produce appropriate foam density and size for subsequent treatment.

Further, the venturi nozzle comprises a nozzle body, a nozzle front-end inlet means and a nozzle rear-end outlet means, one end of the nozzle body is connected with the nozzle front-end inlet means and the other end is connected to the nozzle rear-end outlet means. The venturi nozzle is designed by appropriate geometric surface parameters, and can form water cycles with mass flow, and have spray holes to prevent blockage.

Furthermore, the concentric tube comprises an internal tubular member, an embryo body and an external tubular member, wherein one end of the embryo body is connected with the internal tubular members, and the other end is connected to the external tubular members. Tubular body is prepared by a method in which one tube is radially contracted on the other tube during sintering of the preparation process, so that the article has a radially varying property.

Furthermore, the internal tubular member is also provided with a plurality of concentric layers.

Further, the pressure monitoring device comprises a pressure sensor and a pressure display apparatus, the pressure sensor connected with the pressure display apparatus can sense pressure data formed by fluid in the pressure monitoring device, and can feed it back to pressure display apparatus to remind the operator to pay attention.

Furthermore, the concentric tube is provided with a flow monitoring apparatus.

A further purpose of present invention is to provide a wastewater treatment method, which comprises following steps:

S1. Subjecting air to enter into a dissolving bump, and mix with wastewater;

S2. Subjecting mixed wastewater/air to aerate to produce a mixture of microbubbles and wastewater;

S3. Subjecting the mixed solution to disperse to a flotation cell for filtration and wastewater treatment.

Further, the mixed wastewater/air of the step S2 enters into above multi-stage aeration generator, which can be a combination of one or a series of multiple venturi nozzles and concentric tubes, the microbubbles produce the mixture of the microbubbles and the wastewater to form white solution by several aeration extraction and repeated bubble shear.

Further, the white solution formed by the mixture of the microbubbles and wastewater passes through a spraying device which is provided with a valve to be able to eliminate excessive turbulent water flow, before the white solution of the step S3 being dispersed to flotation cell for filtration and wastewater treatment.

Furthermore, a separation chamber is provided in the middle of the spraying device to release undissolved air, and excessive suspended air and undissolved air is discharged from a top vent pipe of the separation chamber to avoid affecting retention quality.

comparing to prior art, the beneficial effect of technical scheme of present invention is that:

(1) The multi-stage aeration generator disclosed in present invention with novel design, and a combination of a venturi nozzle and a concentric tube, can provide very fine foam continuously and stably, while making output changes immediately for changes in operating parameters input; the multi-stage aeration generator is used to adjust and control air feeding and pump speed to produce appropriate foam density and size for subsequent treatment.

(2) The multi-stage aeration generator disclosed in present invention, the venturi nozzle is designed by appropriate geometric surface parameters, and can form water cycles with mass flow, and has spray holes to prevent blockage.

(3) The multi-stage aeration generator disclosed in present invention has a simple structure and convenient maintenance.

(4) The multi-stage aeration generator disclosed in present invention has low production cost and is suitable for mass production.

### BRIEF DESCRIPTION OF THE DRAWING

FIG. 1 is external structural schematic view of the multi-stage aeration generator in present invention.

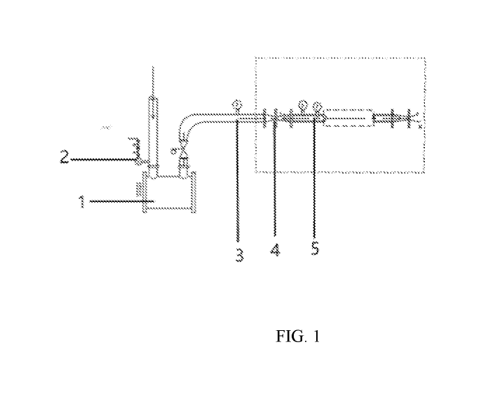

In FIG. 1, 1 denotes a generator body, 2 denotes a pressure monitoring apparatus, 3 denotes a venturi nozzle, 4 denotes a capillary conduit, 5 denotes a concentric tube.

### DETAILED DESCRIPTION OF THE EMBODIMENTS

The accompanying drawings is for illustrative explanation only, and cannot be construed as limiting the scope of the invention; in order to explain embodiments more clearly, certain parts of drawings may be omitted, enlarged or reduced, and do not represent the actual size of the products; it can be understood by those skilled in the art that certain known structure and their description may be omitted in accompanying drawings.

It is necessary to state that terms “installation” and “connection” should be construed broadly, unless explicitly stated and limited, such as, it may be a fixed connection, a removable connection, or an integral connection; it can be a mechanical connection or an electrical connection; it can be directly connected or indirectly connected through an intermediate medium, and it can be an internal connection between two elements. The specific meaning of the aforementioned terms can be understood by those skilled in the art according to specific cases. it will be further described below the technical scheme of present invention with reference to accompanying drawings and embodiments.

As shown in FIG. 1, a multi-stage aeration generator, comprises generator body 1, a pressure monitoring device 2 installed thereon and venturi nozzle 3, and further comprises a capillary tube 4 and a concentric tube 5, wherein one end of the capillary tube is connected to the venturi nozzle, and the other end is connected to the concentric tube. Present invention has novel design, and a combination of the venturi nozzle and the concentric tube, can provide very fine foam continuously and stably, at the same time it can make output changes immediately for changes of operating parameters input; the multi-stage aeration generator is used to adjust and control air feeding and pump speed to produce appropriate foam density and size for subsequent treatment. The venturi nozzle comprises nozzle body, a nozzle front-end inlet means and a nozzle rear-end outlet means, one end of the nozzle body is connected with the nozzle front-end inlet means and the other end is connected to the nozzle rear-end outlet means. The venturi nozzle is designed by appropriate geometric surface parameters, and can form water cycles with mass flow, and has spray holes to prevent blockage. The concentric tube comprises an internal tubular member, an embryo body and an external tubular member, wherein one end of the embryo body is connected with the internal tubular members, and the other end is connected to the external tubular members. A tubular body is prepared by a method in which one tube is radially contracted on the other tube during sintering of the preparation process, so that the article has a radially varying property, the internal tubular member is provided with a plurality of concentric layers, the pressure monitoring device comprises a pressure sensor and a pressure display apparatus, wherein the pressure sensor is connected with the pressure display apparatus, which can sense pressure data formed by fluid in the pressure monitoring device, and can feed it back to pressure display apparatus to remind the operator to notice that the flow monitoring apparatus is provided on the concentric tube. This apparatus can provide very fine foam continuously and stably. Wherein the most prominent achievement is that, it can alter output immediately for changes in operating parameters input; and is used to adjust and control air feeding and pump speed to produce appropriate foam density and size for subsequent treatment, when the air and wastewater are mixed along the inner section of the pump and are gasified to saturation, before entering the combination of the venturi nozzle and the concentric tube, the releasable dissolved gas at a specific liquid pressure forms a “balance of a gas phase and water phase” at this point, according to Henry's law. However, most undissolved air is agitated in the form of relatively large foam mixture to dissolve the air in the liquid, based on the pressure difference between inlet and outlet of the venturi nozzle. A first small foam is “congealed” from saturated gas to form gas foam according to Henry's Law. At this stage, the small batch of foam is extracted, and mixed with large foam (which is formed by the undissolved air after agitation), to prepare stable and very fine foam.

A wastewater treatment method is provided in present invention, which comprises following steps:

S1. Subjecting air to enter into a dissolving bump, and mix with wastewater.

A wastewater treatment method of present invention comprises an air dissolving pump, the air is carried directly into wastewater flow by an air inlet manifold of a pump. The mixture of the air and the wastewater is compressed to 10 bar of designed pressure, wherein to ensure the air to fully enter into the dissolved mixed liquid at soluble ratio (according to Henry's Law), adjust and alter gas input volume such that a desired foam size and a concentration of gas foam can be obtained. In general case, when the pump speed is constant, when air intake increases, size of relative foam will also be larger. Likewise, it can be observed that foam size will reduce by turning up the pump speed under the constant inlet speed, however conventional dissolved air flotation system can only play a role of aeration function under a specific air and wastewater pressure setting.

S2. Subjecting the mixed wastewater/air to enter into the multi-stage aeration generator as described in claims 1-6, to produce a mixture of the microbubbles and the wastewater to form white solution.

The wastewater and air are mixed and transmitted into the aeration generator with a venturi nozzle coupled to a concentric tube, wherein, sectional area of the concentric tube is close to that of inlets of the venturi nozzle, and in which case the pressure can be recovered. The outlet of a first venturi nozzle combined with the concentric tube and a second venturi nozzle are coupled to an inlet of the concentric tube. A plurality of venturi nozzles and concentric tubes are constituted as multi-stage aeration generator. Microbubbles are extracted by multiple aerations and repeated bubble shearing, including the following steps:

(1) firstly, the air and wastewater are mixed along the inner section of the pump and are gasified to saturation, before entering the combination of the first venturi nozzle and the concentric tube, the releasable dissolved gas at a specific liquid pressure forms a “balance of a gas phase and water phase” at this point, according to Henry's law. Most undissolved air is agitated in the form of relatively large foam mixture.

(2) based on the pressure difference between inlet and outlet of the venturi nozzle. The dissolved air in liquid performs according to Henry's Law, thus a first batch of small foam is “congealed” from saturated gas to form gas foam. At this stage, the small foam is extracted, and mixed with large foam (which is formed by the undissolved air after agitation).

(3) At this time, the total cross sections of the concentric tube are equivalent to “(1)”, so the pressure of the liquid is restored. Because the surface tension of the large foam is weaker than that of the microbubbles, large bubbles are broken firstly and the air is firstly dissolved.

(4) the total cross sections of the concentric tube are in equilibrium with “(3)”, the internal distance between two solid tube walls during design can give sufficient turbulent shear force to reduce the volume of microbubble foam.

(5) repeats steps “(2)” to “(4)” until “white water flow” is generated.

Comparing to conventional dissolved air flotation, present invention can conveniently remove hydrophobic and hydrophilic pollutant from the waste water, and the costs of equipment startup and operation are reduced by 30% and 40% respectively. In addition, size of the foam typically is reduced from 10-50 um to 1-10 um, and air solubility is increased from 12% volume/volume to 15-25%, according to Henry's Law, and the temperature of operating liquid can be as high as 45° C.

S3. Subjecting the white solution to disperse to a flotation cell for filtration and wastewater treatment.

Outlet of the multi-stage aeration generator is transmitted to a spraying device by a tube. Wherein, microbubbles and wastewater liquid are mixed together to form white solution, which is dispersed to a flotation cell for filtration and wastewater treatment. The spraying device is not provided with valve means, which can eliminate excessive turbulent water flow. A separation chamber is provided in the middle of a spraying device to be designed to release undissolved air, and excessive suspended air and undissolved bubble is discharged from a top vent pipe of the separation chamber to avoid affecting retention quality.

The spraying device comprises upper and lower metal disk, which is bolted together with adjustable interspace therebetween, to precisely adjust dispersing flow speed for synchronization with a flotation cell and a desilter design. The design of the spraying device is an engineering design, having two functions as follows:

a. dispenses the “white water flow” to flotation cell evenly.

b. extracts and expels undissolved air from the “white water flow”. The two reified purposes are to minimize the accumulation of retention damage formed by air bubble suspending rapidly.

The “white water flow” is discharged from the bottom to the top, and is temporarily retained in the central chamber formed by retaining rings of the upper and lower. The “white water flow” is dispensed slowly to a flotation cell in all aspects. Undissolved air is trapped by interspace in the center of disks, and then overflowed by vent pipes located on the top.

In figures, the description of the positional relation is for illustrative purposes only, and is not to be construed as limiting the scope of the invention. It is to be understood that the above-described embodiments of the present invention are merely illustrative of the invention and are not intended to limit the implementation of the invention. Variations and modifications can also be made by those ordinary skilled in the art in other different ways based on above description. It is not necessary and there is no way to enumerate all embodiments. Any modifications, equivalent substitutions and improvements made within the spirit and principle of the invention are intended to be included within the scope of the appended claims.

1. A multi-stage aeration generator, comprising a generator body, a pressure monitoring device installed thereon, and a venturi nozzle, wherein further comprising: a capillary tube and a concentric tube, one end of said capillary tube connected to the venturi nozzle, and other end connected to the concentric tube.

2. The multi-stage aeration generator as claimed in claim 1, said venturi nozzle comprising nozzle body, nozzle front-end inlet means and nozzle rear-end outlet means, one end of said nozzle body connected with the nozzle front-end inlet means and other end connected to the nozzle rear-end outlet means.

3. The multi-stage aeration generator as claimed in claim 1, wherein said concentric tube comprising an internal tubular member, an embryo body, and an external tubular member, wherein one end of said embryo body being connected to the internal tubular members, and other end being connected to the external tubular members.

4. The multi-stage aeration generator as claimed in claim 3, wherein said internal tubular member is further provided with a plurality of concentric layers.

5. The multi-stage aeration generator as claimed in claim 1, wherein said pressure monitoring device comprises pressure sensor and pressure display apparatus, said pressure sensor being electrically coupled to the pressure display apparatus.

6. The multi-stage aeration generator as claimed in claim 1, wherein said concentric tube is provided with a flow monitoring apparatus.

7-10. (canceled)
